(19) United States
(12) Patent Application Publication
(10) Pub. No.: US 2024/0215543 A1
(43) Pub. Date: Jul. 4, 2024

(54) System and Method for Detecting and Monitoring Species of Wildlife with a Light Detection and Ranging (LiDAR) Multi-Zone Rangefinder and Smart Camera

(71) Applicant: Douglas M. Bonham, ESSEX, MT (US)

(72) Inventor: Douglas M. Bonham, ESSEX, MT (US)

(21) Appl. No.: 18/092,872

(22) Filed: Jan. 3, 2023

(51) Int. Cl. A01K 29/00; G01S 17/89; G06V 10/26; G06V 20/40; G06V 40/10; H04N 23/52

(52) U.S. Cl. CPC A01K 29/005; G01S 17/89; G06V 10/273; G06V 20/47; G06V 40/10; H04N 23/52

(57) ABSTRACT

A system and method for detecting, predicting and monitoring species of wildlife with a light detection and ranging (LiDAR), multi-zone rangefinder (MZR) software and onboard digital camera is disclosed. The system establishes virtual multi-zones in the field of view and when an animal is detected inside data frames within said zones, their location, size, and shapes are converted into voxels and analyzed by artificial intelligence (AI) algorithms to identify them to the species level. Other objects of the system include differentiating animal movements from background movements, minimizing false readings and preserving the onboard power supply.

### CROSS-REFERENCE TO RELATED APPLICATIONS

This application claims the benefit of U.S. Provisional Patent Application No. U.S. 63/296,115 filed on Jan. 3, 2022.

### FIELD OF THE INVENTION

The present invention relates to digital cameras and monitoring systems. More specifically, the present invention is a hardware and software visualization system to detect, identify and monitor species of wildlife.

### BACKGROUND

Trail cameras (also known as game cameras) are remote cameras placed by photographers and researchers in outdoor natural areas where they generally cannot be present to capture such images. These locations include areas with limited access, tight spaces where a person is not allowed, or hazardous areas etc. In some instances, photographers use them to simultaneously capture pictures of wildlife during the same moment from different locations. Trail cameras are also commonly used by hunters to understand the locations and movements of game animals. The origin of trail cameras essentially began in the early 1980s when researchers at the Missouri State University were looking at ways to study whitetail deer behavior using a product made by ‘Trailtimer.’ This camera could record the time a deer tripped a string stretched across a trail. The researchers used the digital camera and projected an infrared beam to a receiver. Several years later researchers in Texas developed a self-contained unit operated by a passive infrared sensor. Wildlife research and monitoring is being revolutionized by the use of such cameras. Most of these research devices acquire images when triggered by a passive infrared sensor (PIR). PIRs require a temperature differential between a moving target—usually a warm-blooded animal and the background. As such, they perform poorly on cold-blooded reptiles, amphibians, fish, insects, etc. Today, trail cameras are considered to be ‘internet of things’ devices with cameras that can stream live video and data directly from remote locations to users wirelessly. Researchers have only just begun to develop AI systems for trail cameras. AI, in herein being defined as decision making by a machine based on criteria such as a machine learning model-based on a training data set, programmed algorithms, fuzzy decision making, or other methods. United States Patent No. US20220327852A1 granted to Monk and Monk established AI algorithms that allow cameras to identify animals down to the species level; however, it only focuses on deer. Some trail cameras incorporate ‘smart cameras’ that can detect moving objects regardless of temperature; however, they use a lot of electrical power and they are prone to falsely-triggering on background plants that move in the wind. In order to minimize recordings triggered by background movements, what is needed is a combination of solid-state LiDAR with Multi-Zone Rangefinder (MZR) software that measures distances to potential targets that includes enhanced analysis of visual data from an independent image sensor in conjunction with AI algorithms to capture, identify and monitor wildlife accurately.

### SUMMARY OF THE INVENTION

The device herein disclosed and described provides a solution to the shortcomings in the prior art through the disclosure of a system and method of detecting wildlife in the field. The system leverages a highly accurate, an onboard digital camera, solid-state LiDAR and MZR software to detect and record animal movements and store them onto onboard memory.

Another object of the system is to use AI to discriminate between animal movement and background movement. The present system provides a device and method to help discriminate high-value targets (such as wildlife) from various sources of background noise (low-value, false positive triggers) such as vegetation blowing in the wind. In order to perform this function, the system overlays the field of view with ‘virtual multi-zones.’ A virtual multi-zone baseline of the landscape with no animals present is established by capturing and storing ‘data frames’ and ‘data summaries’ within said zones. New data frames of the zones are then continuously compared to the background frames in order to predict whether or not any moving animals are present within said virtual multi-zone—herein referred to as a ‘wildlife presence event.’

Another object of the system is to detect and identify cold-blooded animals (such as fish and reptiles) that traditional passive infrared (PIR) sensors cannot. The combination of the onboard digital camera, solid-state LiDAR, and MZR software provides additional data that conventional infrared signals cannot provide. This additional data can include ‘data summaries’ which are not possible to obtain using conventional camera and PIR detectors. The data summaries can be described as multi-dimensional movement of detected subject matter over time and space. Data summaries may be as short as a single data frame or as long as several hours. Data summaries may be represented as numbers (called raw data), in a two-dimensional or three dimensional matrix, as well as color-coded images where data dimensions (such as time and distance) are represented by a color scheme.

Another object of the system is to provide power savings over other camera systems (such as those used in conventional digital trail cameras). Earlier trail cameras tended to activate when all motion was detected—regardless of the subject matter being a high-value or a low-value target. This needless activation often drained onboard resources. The current disclosure also includes a solar panel to aid in recharging the onboard battery. Significant power savings can also come from both simple triggering (such as powering on a camera), through the MZR, and complex evaluation of the special data outputs described later in this specification. The MZR data is much simpler to evaluate than camera photos, allowing for low processor power requirements and thus lowering overall power usage during camera turn-on conditions. The triggering data and subsequent MZR data can be saved as ‘behavioral data’ to increase the value of any photos of videos. A photo of an insect on a flower, for example, can be shown to represent a pollination event by looking at the time-series of movements from the MZR. Conversely, a photo alone cannot imply what the insect or other animals were doing or how fast it was going, and how long the animals may have lingered in a certain location.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the system.

FIG. 2 shows a front view of the unit.

FIG. 3 shows the virtual multi-zone and data frames.

FIG. 4 shows the virtual multi-zone with visual analysis.

FIG. 5 shows a representative view of the method.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

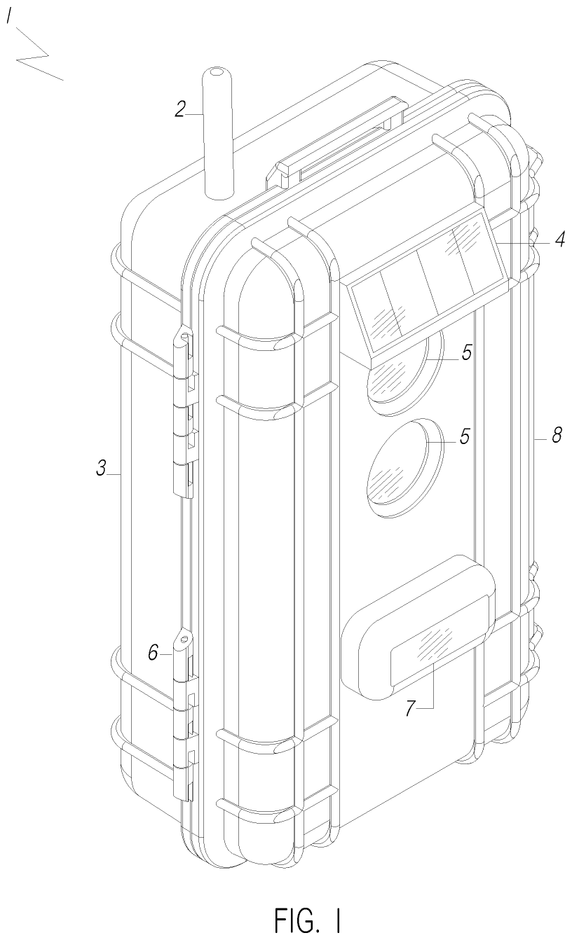

Referring now to FIG. 1, showing a perspective view of the preferred embodiment of the system 1. System 1 comprising a square-shaped, tamperproof, waterproof enclosure 3 with front door 8 (having an internal perimeter O-ring) and hinges 6. Said enclosure 3 being made of a rigid material including but not limited to: metal, fiberglass-reinforced Delrin plastic and the like with onboard solar panels 4, camera windows 5 and LiDAR window 7. A distal side of case 3 having an attachment device that allows the system to be affixed to a vertical surface (such as but not limited to: bolts and strapping etc.). Said solar panel 4 is an optional hardware feature of the present invention that uses sunlight as a source of energy to generate electricity. The solar panel 4 is found on the exterior of the weatherized enclosure 3. The solar panel 4 is utilized to convert sunlight into electricity and is used to recharge the onboard power supply 15.

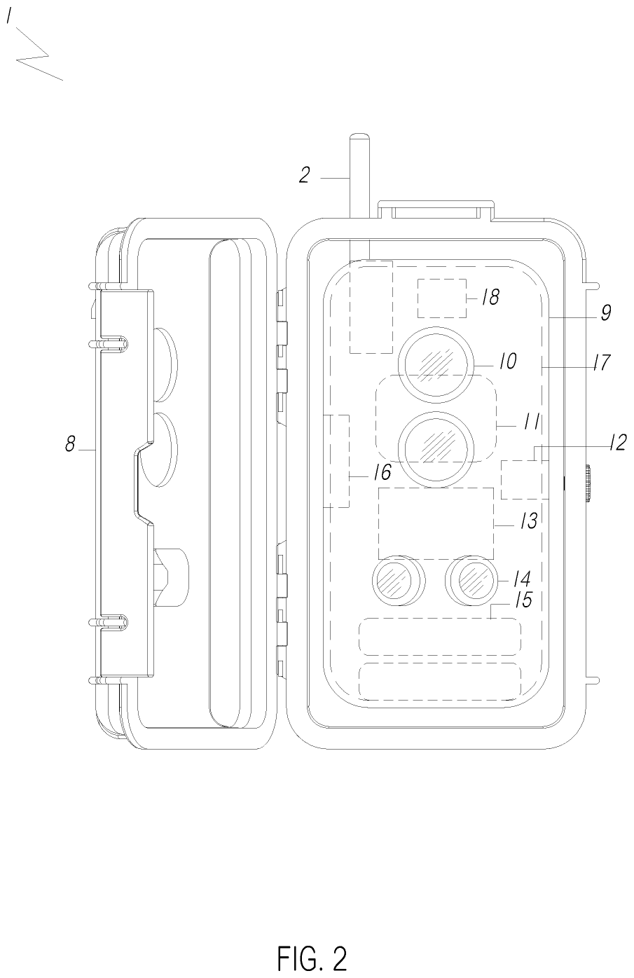

Referring now to FIG. 2, showing a front view of the preferred embodiment of the system 1 with front door 8 of waterproof enclosure 3 open and main unit 9 there inside. Main unit 9 comprising an integrated circuit board 17 having components such as but not limited to: antenna 2; central processing unit (CPU) 11; onboard memory 13; accessible media storage unit 16 (SD, microSD, USB memory stick, etc.); onboard power supply 15 (can include but are not limited to lithium-ion batteries, nickel hydride batteries and the like); outlet ports 12 (can include but are not limited to: 120V and 5V USB ports etc.); wireless transmission module 18 (such as WiFi, Bluetooth etc.); solid-state LiDAR units 14; and onboard digital camera 10 also having infrared filters, diffractive optical sensors, and an array of single-photon, avalanche diodes therein. The aforementioned onboard memory 13 having software that includes AI algorithms that predict the size, shape and species of animals detected by system 1. The CPU 11 is used to execute software instructions. The CPU 11 allows for input and output to occur for the present invention to perform and operate properly. Said software also having routines that overlay virtual multi-zones onto captured digital recordings and can isolate spaces within a virtual multi-zone—herein referred to as ‘data frames.’

The aforementioned antenna 2 is a hardware electronic component of the present invention that receives and/or transmits radio frequency electromagnetic waves from one wireless point to another wireless point. In the preferred embodiment, the antenna 2 is used to transmit radio frequencies/radio electromagnetic waves from the present invention to a smart device of the user. The antenna 2 has a primary function of transmitting and receive signals between multiple wireless points. The antenna 2 is also connected to wireless transmission module 18.

The aforementioned wireless transmission module 18 is an electronic component that can data send and/or commands to or from a user or additional computing resources. Other embodiments can include wireless transmission module 18 having real-time notification and feeds of detected events or diagnostic information. Other embodiments can also have long-distance wireless communications can also include long range (LoRa), long range wide area network (LoRaWAN), cellular (LTE), Zigbee, Starlink, Globalstar, and other satellite systems that can be added for both rapid notification and system diagnostics. Still other embodiments of the invention can have additional sensors that can be used to enhance the overall detection and measurement of the present invention. Additional sensors may include, but are not limited to, a microphone, passive infrared (IR) sensors, weather sensors, etc.

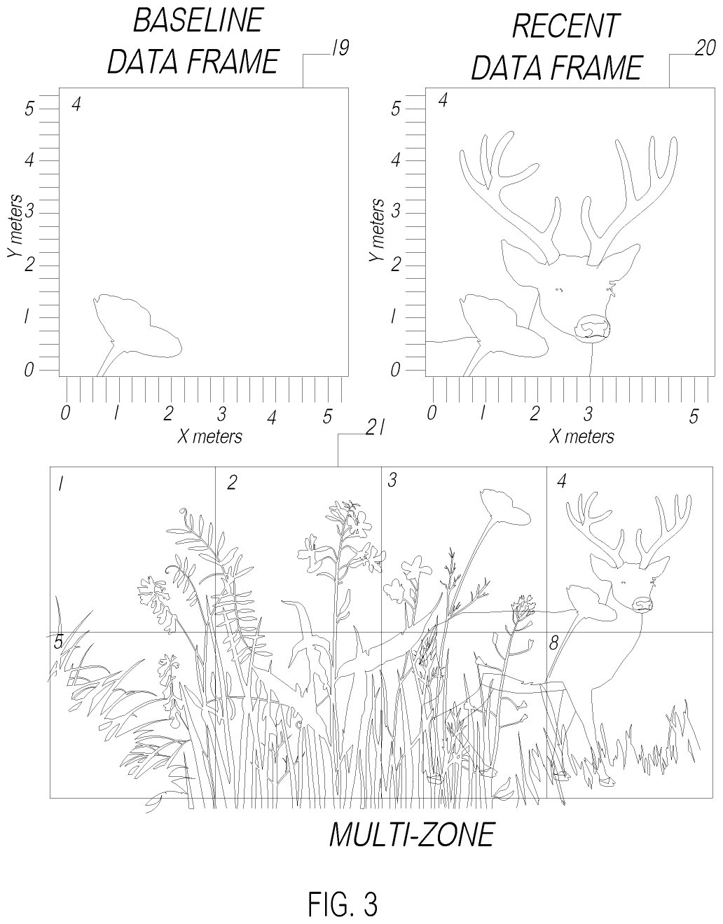

Referring now to FIG. 3, showing an example of the aforementioned virtual multi-zone overlain onto system 1's field of view within said onboard high-definition, digital camera images. The preferred embodiment of said software having the ability to measure X, and Y distances (in meters and feet etc.) to a detected feature within a data frame and Z distances to said detected features using the solid-state LiDAR unit 14 thereby capturing three dimensions of wildlife. Once footage is captured, the software removes undesirable background images surrounding a potential target. Following background removal, the preferred software embodiment will map the position of an animal overtime using the MZR. After removal of background and foreground with a ‘filtering step,’ only the desired animal will remain in the data. The distance from the unit can be tracked over time, creating a depth map. This depth map can be color coded for distance, or as a raw numerical matrix or array of distances. The time for each depth point to be detected can be layered on a ‘depth map’ showing when the animal was at each location, in either color coding or raw numerical data. By using mathematical formulas to track the animal over time, another form of data, paths of motion (sometimes called vectors), can be created. An animal's location, (nearness to the unit's camera), duration of movement, and direction of movement may all be recorded in the preferred embodiment.

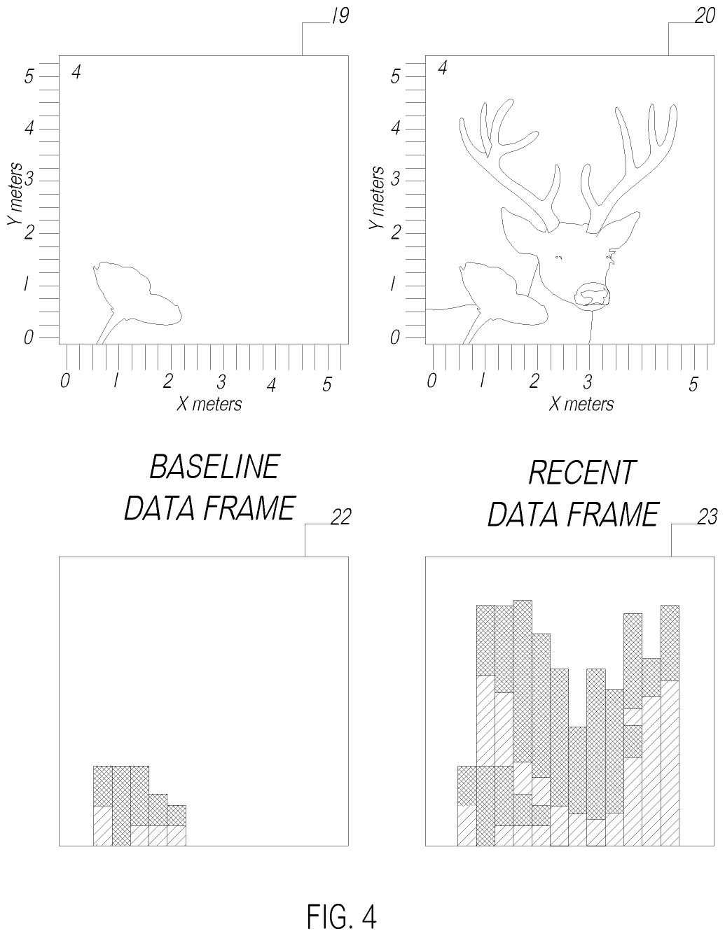

All combined, digital visual and metric dimensional data is then used by the AI that compares this data with an onboard library of existing wildlife shapes and sizes to predict the detected animal's species. The figure also showing an example of what system 1 sees when comparing baseline data frames with background features (vegetation etc.) to a recent data frame that has captured a ‘wildlife presence event.’ As previously stated, the same process for background removal is used for foreground removal with regards to bits of debris, snow, moving leaves, or similar items that can cause an unwanted activation of the unit. The AI also performs this comparison to predict or rule out a wildlife presence event within a virtual multi-zone. The software running on the device can accumulate a series of data frames to build a model of average, minimum and variance of distances within a virtual multi-zone. After this baseline data is compiled, CPU 11 then watches for data frames that suddenly report a closer X, Y or Z distance or a burst of higher distance variance from the baseline data frame distances. Such detections can then trigger additional image and solid-state LiDAR acquisition for further AI analysis of potential target animals. Additional details on these software features are also discussed further in the next methods section. Referring now to FIG. 4 showing an example of side-by-side images of what the onboard high-definition, digital camera sees and what the solid-state LiDAR sees when data frames are captured by system 1. These images are combined into ‘voxels.’ The system divides the field of view into evenly spaced rows and columns, covering all three different directions (X, Y, and Z as mentioned). This 3D division generates cubes, also known as voxels (volume elements or volumetric pixels). Each voxel is defined by a 3D coordinate (as established by the onboard, high-definition camera and solid-state LiDAR) and the color at that coordinate. These voxels are fed into the AI software for comparative analysis and species determination.

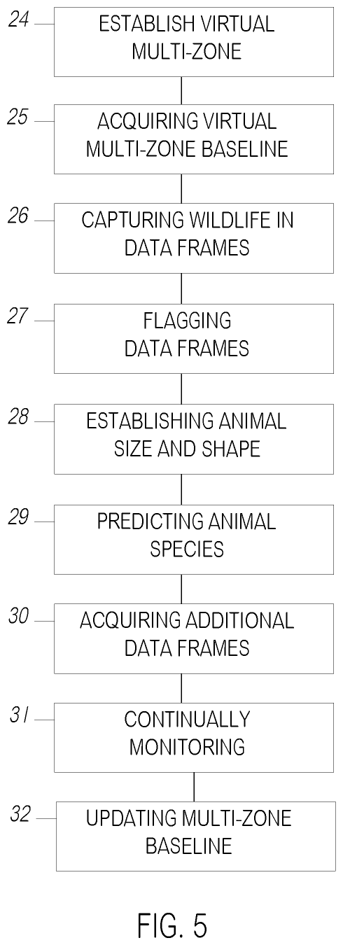

Referring now to FIG. 5, showing the method of system 1 that includes but is not limited to the following steps: Item 24 establishing a virtual multi-zone on the onboard, camera's field of vision; Item 25 acquiring a virtual, multi-zone baseline of the environment in a three-dimensional data frame; Item 26 capturing instances of wildlife presence events in data frames after an animal enters and moves within the virtual multi-zone; Item 27 flagging data frames when recording is activated and time stamping data file with metadata; Item 28 establishing animal size and shape by calculating X, Y and Z distances from the data frames within the multizone to the animal, converting these readings into voxels and feeding them to the software for AI interpretation; Item 29 the AI then comparing voxel data with voxel data from known species and predicting the species of the animal detected by system 1; Item 30 system 1 then acquiring additional data frames to enhance validity of the prediction; Item 31 continually monitoring the movement of the wildlife detected; and Item 32 after wildlife is no longer available, system 1 updating the virtual multi-zone baseline after it has deemed changes have occurred and a new baseline is necessary.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications. In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® Quick Time®.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A system for detecting, predicting, and monitoring species of wildlife comprising the following parts:
a) a weather resistant enclosure;
b) a main unit;
c) an onboard digital camera;
d) a solid-state LiDAR;
e) an onboard power supply;
f) a software program on a non-transitory computer readable medium including computer readable instructions.

2. The system for detecting, predicting, and monitoring species of wildlife of claim 1, wherein the weather resistant enclosure further comprising a front door with camera and LiDAR windows and an internal perimeter O-ring, hinges and an attachment device.

3. The system for detecting, predicting, and monitoring species of wildlife of claim 1, wherein the main unit further comprising an integrated circuit board, an antenna, a central processing unit, onboard memory, an accessible media storage unit, outlet ports, a wireless transmission module.

4. The system for detecting, predicting and monitoring species of wildlife of claim 1, wherein the onboard digital camera and solid state LiDAR with MZR software further comprising infrared filters, diffractive optical sensors, and an array of single-photon, avalanche diodes.

5. The system for detecting, predicting, and monitoring species of wildlife of claim 1, wherein the software further comprising virtual multi-zones, data frames and AI algorithms that predict the size, shape and species of animals detected. establishing the virtual multi-zone within the on the onboard, high-definition camera's field of vision

6. A method for detecting, predicting, and monitoring species of wildlife comprising the following steps:
a) providing the system for detecting, predicting, and monitoring species of wildlife of claim 1;
b) acquiring the virtual multi-zone baseline of the environment in a three-dimensional data frame;
c) capturing instances of wildlife presence events in data frames and data summaries after an animal enters and moves within the virtual multi-zone;
d) removal of background and foreground;
e) flagging data frames when recording is activated and time stamping data file with metadata;
f) comparing recently acquired data frames with baseline data frames and confirming wildlife is present;
g) establishing animal size and shape of an animal;
h) predicting the species of the animal detected acquiring additional data frames; and
i) updating the virtual multi-zone baseline after it has deemed changes have occurred and a new baseline is necessary.

7. The method for detecting, predicting, and monitoring species of wildlife of claim 6, wherein the comparing recently acquired data frames with baseline data frames and confirming wildlife is present includes the step of detecting significant differences.

8. The method for detecting, predicting and monitoring species of wildlife of claim 6, wherein the establishing animal size and shape of an animal further comprising the step of acquiring additional data frames to enhance validity of the prediction; and

9. The method for detecting, predicting, and monitoring species of wildlife of claim 6, wherein the predicting the species of the animal detected acquiring additional data frames includes the step of the AI comparing voxel data with voxel data from known species.
